(19) United States
(12) Patent Application Publication
(10) Pub. No.: US 2011/0264828 A1
(43) Pub. Date: Oct. 27, 2011

(54) Method of Monitoring Connection Status of an Electronic Device and Related Electronic device

(76) Inventors: Ping-Shun Zeung, Taipei County (TW); Chien-Kuan Ho, Taipei County (TW)

(21) Appl. No.: 12/765,837

(22) Filed: Apr. 22, 2010

(51) Int. Cl. G06F 3/00

(52) U.S. Cl. 710/16

(57) ABSTRACT

A method of monitoring connection status for an electronic device coupled to a computer device and comprising a plurality of ports. The method comprises detecting whether each of the plurality of ports is connected to a peripheral device according to an interface feature of each of the plurality of ports, and when one of the plurality of ports is detected to be connected to the peripheral device, reporting a connection status of the port to the computer device.

### BACKGROUND OF THE INVENTION

1. Field of the Invention

The present invention relates to method and related device, and more particularly, to a method of monitoring connection status of an electronic device and related electronic device.

2. Description of the Prior Art

USB (Universal Serial Bus) is a specification to establish communication between peripheral devices and a computer system, and is intended to replace many varieties of serial and parallel ports. USB can connect various peripheral devices such as mice, keyboards, digital cameras, printers, personal media players, flash drives, and external hard drives, and supports plug and play (PNP) function. As a result, for many of those devices, USB has become the standard connection method.

A dock device is developed based on the USB technique, which provides additional connectivity for other peripheral devices, and requires only one USB port from a computer device (e.g. a notebook or a personal computer) to connect with. This can be especially helpful for the computer device with a limited number of USB port. For dock device implementation, the dock device provides multiple ports with different interfaces, such as Digital Visual Interface (DVI) port, USB port, Personal System/2 (PS/2) port, IEEE 1394 port, phone jack, network port, etc for those peripheral devices plugged in. Therefore, when the dock device is connected to the computer device, the peripheral devices attached to the dock device can be accessed from the dock device without having to plug each of the peripheral devices into the computer device, thereby facilitating usage of convenience.

Generally, the dock device may include some indicators for indicating statuses of the dock device. U.S. Pat. No. 7,532,461 describes a dock device, which is coupled to a computer device and includes a plurality of ports, a plurality of port status indicators corresponding to the plurality of ports, and a sense circuit. In this patent, the ports are used for connecting with peripheral devices such as mouse, network, printer, keyboard, display unit, etc. The sense circuit is coupled to the port status indicators, and is used for determining whether each of the ports is in active/inactive status by sensing a signal on a bus used for communicating the peripheral device and the computer device, thereby driving the corresponding port status indicator to display status (e.g. active/inactive) of the port according to the signal.

As can be seen, the conventional dock device is capable of indicating work status (e.g. the active/inactive status) of the port by directly detecting the signal transmitted between the computer device and the peripheral device. However, it requires a complex circuit to determine if the port is in active for data transmission by detecting the signal on the bus. In addition, instead of knowing the work status of the ports on the dock device, connection status of the ports with the peripheral devices shall be known in advance. Without knowing connection status of the ports, a user cannot confirm whether the peripheral device is successfully connected to the dock device or not. For example, the user may perform plug in or plug out action for the peripheral devices, or forget to turn on the power of the peripheral devices, and thereby has to check the connection condition of physical wires between each of the dock ports and the peripheral device every time, causing inconvenient usage and a waste of time.

### SUMMARY OF THE INVENTION

It is thereof an objective of the present invention to provide an electronic device capable of monitoring connection status of external devices of the electronic device and method thereof.

The present invention discloses a method of monitoring connection status for a dock device coupled to the computer device and comprising a plurality of ports. The method comprises detecting whether each of the plurality of ports is connected to a peripheral device according to an interface feature of each of the plurality of ports, and when one of the plurality of ports is detected to be connected to the peripheral device, reporting a connection status of the port to the computer device.

The present invention further discloses a dock device coupled to a computer device and capable of monitoring connection status. The dock device comprises a plurality of ports for connecting to a plurality of peripheral devices, and a control unit for detecting whether each of the plurality of ports is connected to one of the plurality of peripheral devices according to an interface feature of each of the plurality of ports, and when the port is detected to be connected to the peripheral device, reporting a connection status of the port to the computer device.

The present invention further discloses a method of monitoring connection status of a dock device for a computer device, where the dock device comprises a plurality of ports each capable of connecting to a peripheral device. The method comprises determining whether a connection status related to one of the plurality of ports is reported from the dock device, and displaying a splash screen with the connection status when the connection statuses is reported from the dock device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a dock device according to an example of the present invention.

FIG. 2 is a flowchart of a process according to an example of the present invention.

FIG. 3 illustrates ways of detecting the connection statuses of a dock device.

FIG. 4 illustrates an exemplary dock device according to an example of the present invention.

FIGS. 5-6 are flowcharts of processes according to examples of the present invention.

FIG. 7 is a schematic diagram of a splash screen according to an example of the present invention.

### DETAILED DESCRIPTION

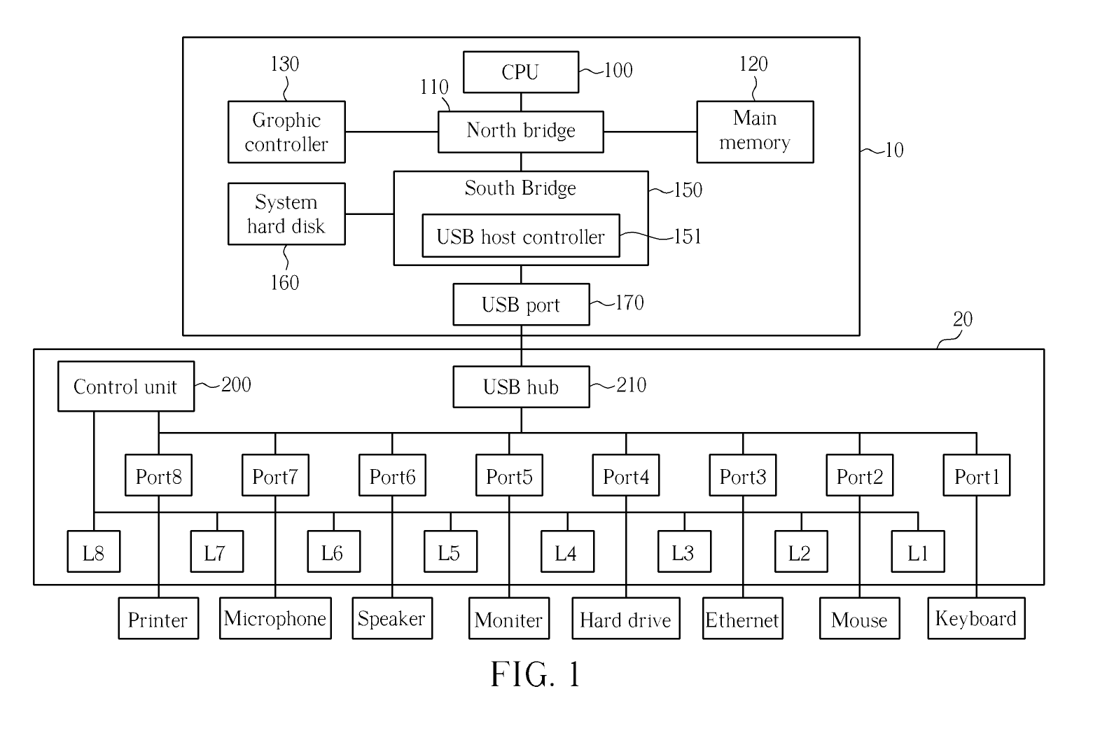

Please refer to FIG. 1, which is a schematic diagram of a dock device 20 according to an example. In FIG. 1, the dock device 20 is connected to a computer system 10, such as a notebook or a personal computer (PC). The dock device 20 includes a control unit 200, such as a USB (Universal Serial Bus) HID (Human Interface Device), a USB hub 210, ports Port1-Port 8, and status indicators L1-L8 corresponding to the ports Port1-Port8 respectively. The ports Port1-Port 8 may be a USB port, a Digital Visual Interface (DVI) port, a printer port, a network port, a telephone jack, an audio port, a modem port, a Personal System/2 (PS/2) port, a IEEE 1394 port, and a RS-232 port, and are used for connecting with peripheral devices, such as a printer, a microphone, a speaker, a monitor, a hard drive, an Ethernet, a mouse, a keyboard, etc. The control unit 200 is coupled to the ports Port1-Port8 and the status indicators L1-L8, and is responsible for performing an enumeration process to the computer device 10 and for controlling the status indicators L1-L8. In some examples, the status indicators L1-L8 include a light emitting diode (LED) set, a vibration, or an audio sound. The USB hub 210 is coupled to the ports Port1-Port8, and is used for connecting the ports Port1-Port8 with a USB port 170 on the computer device 10. On the other hand, the computer system 10 includes a central processing unit (CPU) 100, a north bridge 110, a main memory 120, a graphic controller 130, a south bridge 150, a system hard disk 160, and the USB port 170. The north bridge 110 is usually a single chip in a core logic chipset that connects the CPU 100 to the main memory 120 and the graphic controller 130. The south bridge 150 is usually the chip in a system core logic chipset that controls USB bus, provides plug-and-play support, and comprises a USB host controller 151 to communicate with the peripheral devices (e.g. the mouse, keyboard, etc) connected to the ports Port1-Port8. The components of the computer device 10, such as the CPU 100, the north bridge 110, the main memory 120, the graphic controller 130, etc are well know for the person having ordinary skill in the art, so the detailed description is omitted herein.

For an operation between the dock device 20 and the computer device 10, when the dock device 20 is connected to the computer device 10 through the USB port 170, the control unit 200 and the ports Port1-Port8 are powered via the USB bus. After the control unit 200 is powered, the control unit 200 is enumerated to the computer device 10, and sends dock information to the computer device 10. The enumeration process comprises a device description, such as Vendor identification (VID)/Product identification (PDI) of the dock device 20 required by the computer device 10. In an example, the dock information is a dock picture, a physical layout, or metadata. After requiring necessary information from the dock device 20, the computer device 10 can communicate with the dock device 20. Therefore, when a peripheral device (e.g. a mouse) is plugged into the one of the ports Port1-Port8, the computer device 10 can access the peripheral device through the dock device 20.

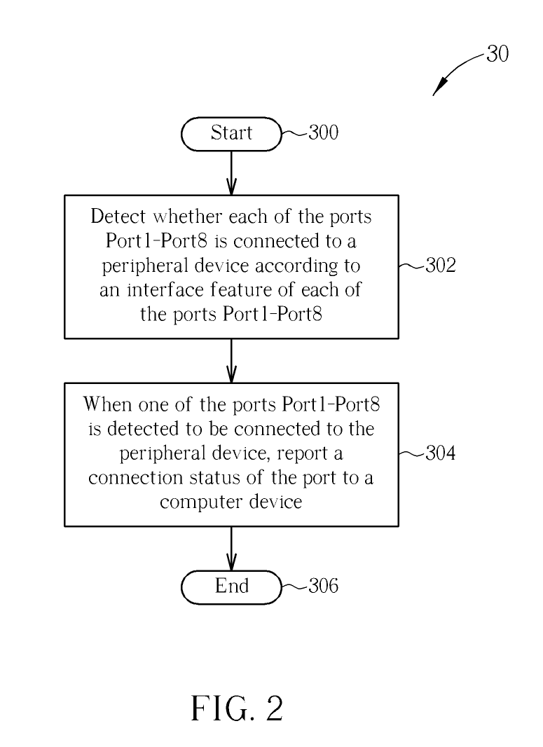

Please refer to FIG. 2, which is a flowchart of a process 30 according to an example of the present invention. Through the process 30, the dock device 20 can monitor connection statuses of the ports Port1-Port8. The process 30 can be applied to a firmware of the dock device 20, and includes the following steps:

Step 300: Start.

Step 302: Detect whether each of the ports Port1-Port8 is connected to a peripheral device according to an interface feature of each of the ports Port1-Port8.

Step 304: When one of the ports Port1-Port8 is detected to be connected to the peripheral device, report a connection status of the port to a computer device.

Step 306: End.

According to the process 30, the dock device 20 detects if any of the ports Port1-Port8 is connected to a peripheral device according to the interface feature of the port. If one of the ports Port1-Port8 is detected to be connected, the dock device 20 then reports the connection status of the port to the computer device 10. Preferably, the interface feature includes a detecting pin, an interface controller, an interface bus, and a mechanical switch.

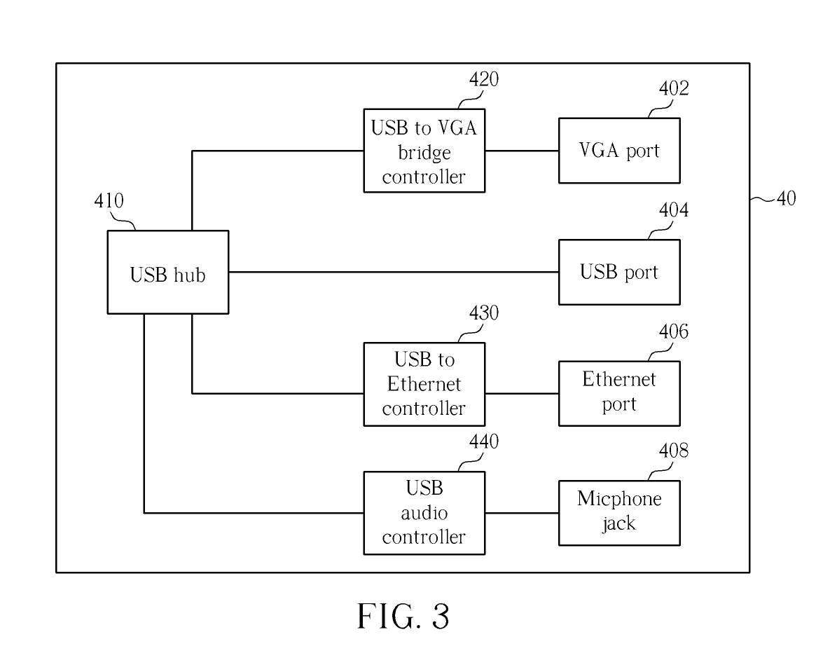

Based on the process 30, the ways of detecting the connection statuses of the ports are different according to the interfaces of the ports Port1-Port8. Please refer to FIG. 3, which illustrates ways of detecting the connection statuses of a VGA (Video Graphics Array) port 402, a USB port 404, an Ethernet port 406, and a microphone jack 408 on a dock device 40. The dock device 40 is connected to a computer device, which can be the computer device 10 shown in FIG. 1. In addition, the dock device 40 can be an example of the dock device 20 shown in FIG. 1. For simplicity, only components related to connection statue detection are shown in FIG. 3. In FIG. 3, the dock device 40 includes a USB hub 410, a USB to VGA bridge controller 420, a USB to Ethernet controller 430, and a USB audio controller 440. The USB hub 410 is coupled to the USB to VGA bridge controller 420, the USB to Ethernet controller 430, and the USB audio controller 440 via USB buses. The USB to VGA bridge controller 420, the USB to Ethernet controller 430, and the USB audio controller 440 correspond to the VGA port 402, the Ethernet port 406, and the microphone jack 408, respectively. In addition to the microphone jack 408, the USB audio controller 440 may couple to an earphone jack. The detailed description for the earphone jack is omitted herein since a way of detecting connection state of the earphone jack is similar to the microphone jack 408. For the VGA port 402, the connection status is detected via an I2C (Inter-IC bus) bus used for communicating with the USB to VGA bridge controller 420. When the VGA port 402 is connected to a peripheral device, a VGA signal is transmitted to the USB to VGA bridge controller 420 through the I2C bus. After that, the USB to VGA bridge controller 420 determines the VGA port 402 is connected, and then signals to the control unit 200 (referred to FIG. 1). Thus, the control unit 200 further reports the connection status of the VGA port 402 to the computer device 10. For the Ethernet port 406 (e.g. RJ-45 jack), the connection status is detected via the USB to Ethernet controller 430. When a RJ-45 cable is plugged into the RJ-45 jack, the USB to Ethernet controller 430 directly signals to the control unit 200. Thus, the control unit 200 reports the connection status of the Ethernet port 406 to the computer device 10. For the microphone jack 408, the connection status is detected via the USB audio controller 440. When a microphone is plugged into the microphone jack 408, the USB audio controller 440 determines that the microphone is connected by the existed mechanism of the microphone jack 408. Similarly, the USB audio controller 440 signals to the control unit 200, and the control unit 200 reports the connection status of the microphone jack 408 to the computer device 10. In addition, the control unit 200 may turn on the status indicator (referred to FIG. 1) corresponding to the detected port for indicating that the port is in the connection status. For the USB port 404, a method of detecting connection state of an USB port is provided as follows.

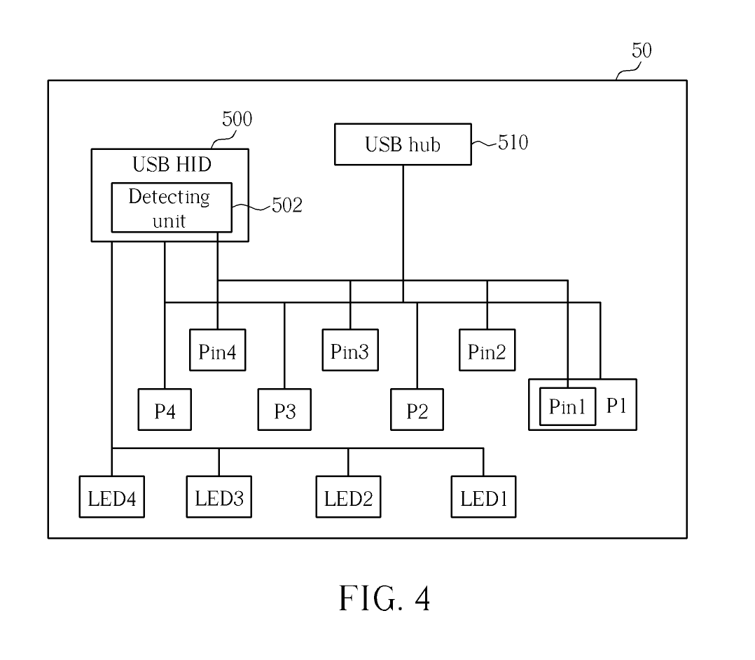

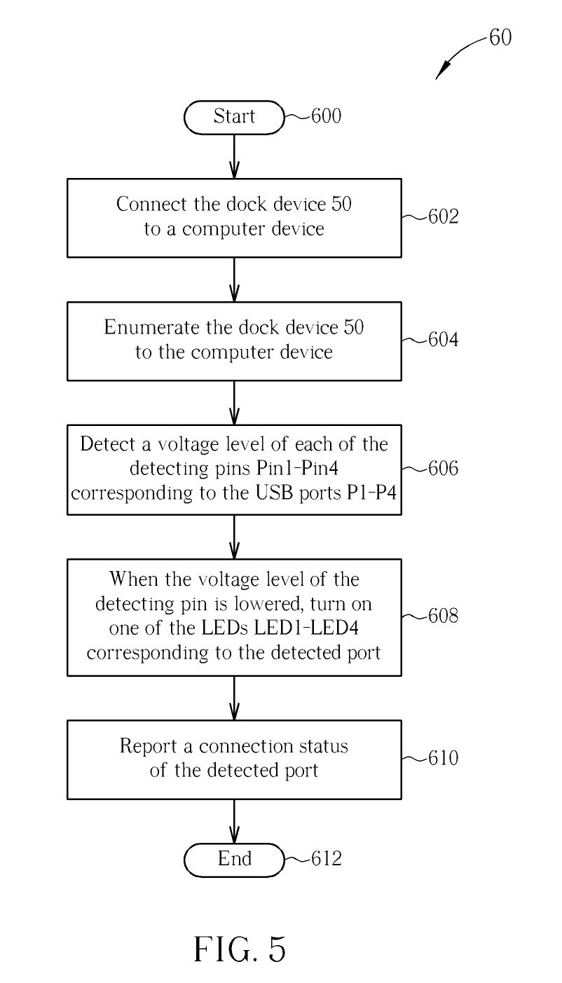

Please refer to FIG. 4, which illustrates an exemplary dock device 50 according to an example. The dock device 50 includes a USB HID 500, a USB hub 510, USB ports P1-P4, detecting pins Pin1-Pin4, and LEDs LED1-LED4 corresponding to the USB ports P1-P4. The detecting pins Pin1-Pin4 are corresponding to the USB ports P1-P4 and may be installed on the USB ports P1-P4 respectively. The USB HID 500 includes a detecting unit 502 used for detecting a voltage change of the detecting pins P1-P4. The detecting unit 502 can be realized a voltage sensing circuit. According installation of the detecting pins Pin1-Pin4, the USB HID 500 can determine whether the USB ports P1-P4 is connected to the peripheral devices. Please refer to FIG. 5, which illustrate a flowchart of a process 60 according to an example. The process 60 can be applied to a firmware of the USB HID 500, and includes the following steps:

Step 600: Start.

Step 602: Connect the dock device 50 to a computer device.

Step 604: Enumerate the dock device 50 to the computer device.

Step 606: Detect a voltage level of each of the detecting pins Pin1-Pin4 corresponding to the USB ports P1-P4.

Step 608: When the voltage level of the detecting pin is lowered, turn on one of the LEDs LED1-LED4 corresponding to the detected port.

Step 610: Report a connection status of the detected port to the computer device.

Step 612: End.

According to the process 60, firstly, the dock device 50 is connected to a computer device, which can be the computer device 10, and thereby the ports P1-P4 and the USB HID 500 are powered. After that, the USB HID 500 starts the abovementioned enumeration process and sends information of the dock device 50 to the computer device 10. Subsequently, the detecting unit 502 of the USB HID 500 detects the voltage level of each of the detecting pins P1-P4. The detecting pins Pin1-Pin4 installed on the ports P1-P4 have their voltage levels pulled high when no peripheral device is plugged in. Once one of the detecting pins Pin1-Pin4 has the voltage level pulled low to ground, this means a peripheral device is plugged in. That is, the physical position of the detecting pins Pin1-Pin4 are changed and thereby contacted to a metal shielding of the ports P1-P4. The USB HID 500 then determines that the port is connected to the peripheral device according to the voltage level change, and reports the connection status of the port to the computer device 10. In addition, the USB HID 500 turns on the LED of the connected port to indicate a user that the port is in the connection status. On the other hand, if no voltage level change occurs on any of the detecting pins Pin1-Pin4, the USB HID 500 determines that the port is not connected to any peripheral devices, and the detecting unit 502 of the USB HID 500 keeps detecting the voltage change of the detecting pins P1-P4.

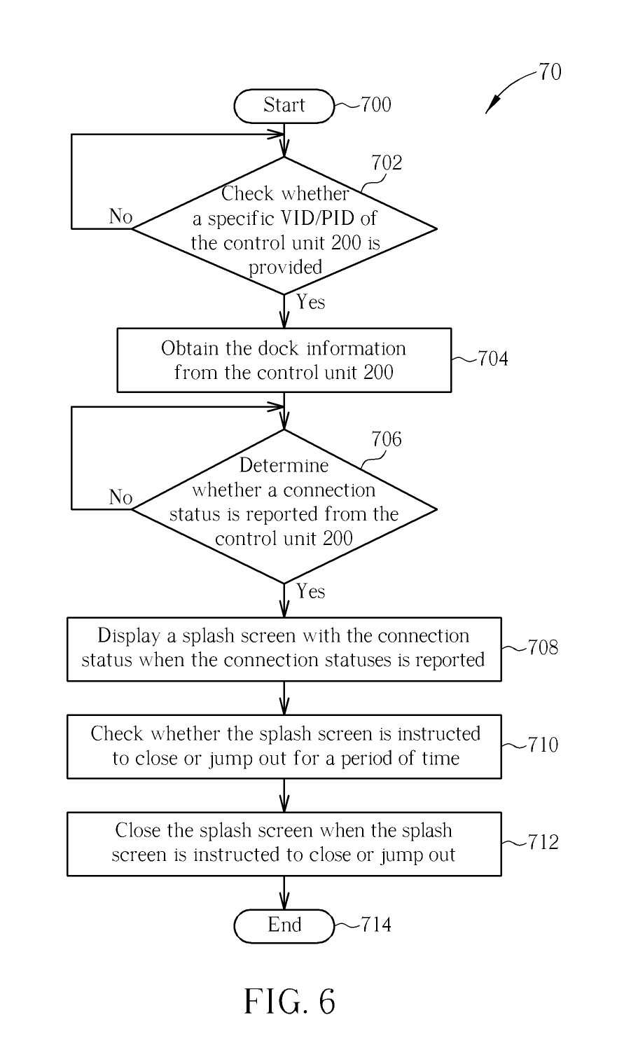

Please refer to FIG. 6, which is a flowchart of a process 70 according to an example of the present invention. Through the process 70, a computer device (i.e. the computer device 10) can monitor connection statues of a dock device (i.e. the dock device 20). The process 70 can be applied to the computer device 10, and includes the following steps:

Step 700: Start.

Step 702: Check whether a specific VID/PID of the control unit 200 is provided. If yes, go to step 704; otherwise, continue step 702.

Step 704: Obtain the dock information from the control unit 200.

Step 706: Determine whether a connection status is reported from the control unit 200. If yes, go to step 708; otherwise, continue step 706.

Step 708: Display a splash screen with the connection status when the connection statuses is reported.

Step 710: Check whether the splash screen is instructed to close or jump out for a period of time. If yes, go to step 712; otherwise, continue step 710.

Step 712: Close the splash screen when the splash screen is instructed to close or jump out.

Step 714: End.

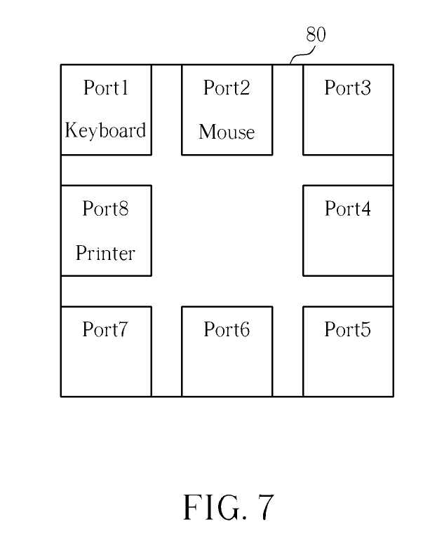

According to the process 70, the computer device 10 determines whether the dock device 20 is docked on the computer device by checking the specific VID/PID associated with the dock device 20. If no specific VID/PID is found, the computer device 10 determines that no dock device is docked on, and keeps checking the existence of the dock device 20. If the specific VID/PID associated with the dock device 20 exists, the computer device 10 commands the dock device 20 to send the dock information, such as dock picture, layout, or metadata. After that, the computer device 10 checks whether a connection status related to one of the ports on the dock device 20 is reported. If no connection status is reported, the computer device 10 keeps checking whether the dock device 20 sends the connection status. On the other hand, if the computer device 10 receives the connection status from the dock device 20, the computer device 10 then displays a splash screen to indicate connection statuses of the dock device 20 on a monitor according to the connection statuses. Preferably, the splash screen includes a layout which indicates a physical position relationship of the port and what kind of the peripheral device is connected to the port on each physical position. FIG. 7 is a schematic diagram of a splash screen 80 according to an example. As can be seen, the splash screen shows the connection status of the dock device 20, where the port Port1 (referred to FIG. 1) is connected to the keyboard, the port Port 2 is connected to the mouse, and the port Port8 is connected to the printer. By the splash screen 80, a user can know what device is connected to a port of the dock device 20. In addition, the user can click the device connected to the port to execute some functionality related to the device. For example, if the user clicks the printer of Port 8 in splash screen 80, the printer can be set up. Moreover, the computer device 10 checks if a user closes the splash screen or presses ESC button on the keyboard. If the computer device 10 is instructed to close or jump out the splash screen, the splash screen then is closed. In an example, if the computer device 10 does not receives instruction from the user, the computer device 10 waits for a period of time, such as 5 second. After 5 second timeout, the computer device 10 automatically closes the splash screen.

In conclusion, the exemplary methods and means are provided to detect connection statuses of different ports on the dock device. In addition, the examples reveal ways of monitoring connection status of the dock device in the hardware (e.g. the status indicator) and software (e.g. the splash screen) aspect. As a result, the user can know the connection status of the ports with information on screen instead of checking the ports of the dock device one by one, thereby increasing usage of convenience.

Those skilled in the art will readily observe that numerous modifications and alterations of the device and method may be made while retaining the teachings of the invention.

What is claimed is:

1. A method of monitoring connection status for an electronic device coupled to a computer device, the electronic device comprising a plurality of ports, the method comprising:
detecting whether each of the plurality of ports is connected to a peripheral device according to an interface feature of each of the plurality of ports; and
when one of the plurality of ports is detected to be connected to the peripheral device, reporting a connection status of the port to the computer device.

2. The method of claim 1, wherein the interface feature of each of the plurality of ports includes a detecting pin, an interface controller, an interface bus or a mechanical switch.

3. The method of claim 2, wherein detecting whether the port is connected to the peripheral device according to the interface feature of the port comprises:
installing the detecting pin on the port;
the detecting pin contacting a metal shielding of the port when the peripheral device is plugged into the port, whereby a voltage level of the detecting pin changes; and
according to the change of the voltage level, determining that the port is connected to the peripheral device.

4. The method of claim 1 further comprising turning on a status indicator of the electronic device corresponding to the detected port for indicating that the port is in the connection status.

5. The method of claim 4, wherein the status indicator includes a light emitting diode (LED) set, a vibration, or an audio sound.

6. The method of claim 1, wherein the plurality of ports include a universal serial bus port, a Digital Visual Interface (DVI) port, a printer port, a network port, a telephone jack, an audio port, a modem port, a Personal System/2 (PS/2) port, a IEEE 1394 port, and a RS-232 port.

7. A electronic device coupled to a computer device and capable of monitoring connection status comprising:
a plurality of ports for connecting to a plurality of peripheral devices; and
a control unit for detecting whether each of the plurality of ports is connected to one of the plurality of peripheral devices according to an interface feature of each of the plurality of ports, and when the port is detected to be connected to the peripheral device, reporting a connection status of the port to the computer device.

8. The electronic device of claim 7, wherein the interface feature of each of the plurality of ports includes a detecting pin, an interface controller, an interface bus, or a mechanical switch.

9. The electronic device of claim 8, wherein the detecting pin is installed on the port, and contacts a metal shielding of the port when the peripheral device is plugged into the port, whereby a voltage level of the detecting pin changes, and the control unit determines that the port is connected to the peripheral device according to the change of the voltage level.

10. The electronic device of claim 6, wherein the control unit turns on a status indicator of the electronic device corresponding to the detected port for indicating that the port is in the connection status.

11. The electronic device of claim 10, wherein the status indicator includes a light emitting diode (LED), a vibration, or an audio sound.

12. The electronic device of claim 7, wherein the plurality of ports include a universal serial bus port, a DVI port, a printer port, a network port, a telephone jack, an audio port, a modem port, a PS/2 port, a IEEE 1394 port, and a RS-232 port.

13. A method of monitoring connection status of an electronic device for a computer device, the electronic device comprising a plurality of ports each capable of connecting to a peripheral device, the method comprising:
determining whether a connection status related to one of the plurality of ports is reported from the electronic device;
displaying a splash screen with the connection status when the connection statuses is reported from the electronic device.

14. The method of claim 13 further comprising:
checking whether the splash screen is instructed to close or jump out; and
closing the splash screen when the splash screen is instructed to close or jump out.

15. The method of claim 13, wherein the splash screen further comprises a layout which indicates a physical position relationship of the plurality of ports and what kind of the peripheral device is connected to the port.

16. The method of claim 13, wherein the plurality of ports include a universal serial bus port, a DVI port, a printer port, a network port, a telephone jack, an audio port, a modem port, a PS/2 port, a IEEE 1394 port, and a RS-232 port.
